(19) United States
(12) Patent Application Publication
(10) Pub. No.: US 2024/0180256 A1
(43) Pub. Date: Jun. 6, 2024

(54) POWER SUPPLY UNIT OF AEROSOL GENERATING DEVICE, AEROSOL GENERATING DEVICE, AND CONTROL METHOD OF AEROSOL GENERATING DEVICE

(71) Applicant: JAPAN TOBACCO INC., Tokyo (JP)

(72) Inventor: Tatsuya HIRABAYASHI, Tokyo (JP)

(73) Assignee: JAPAN TOBACCO INC., Tokyo (JP)

(21) Appl. No.: 18/443,822

(22) Filed: Feb. 16, 2024

Related U.S. Application Data
(63) Continuation of application No. PCT/JP2021/030441, filed on Aug. 19, 2021.

(51) Int. Cl. A24F 40/53; A24F 40/40; A24F 40/57; H05B 1/02

(52) U.S. Cl. CPC A24F 40/53; A24F 40/40; A24F 40/57; H05B 1/0244

(57) ABSTRACT

A power supply unit of an aerosol generating device includes: a housing; a power supply; an aerosol generator configured to generate an aerosol from an aerosol source by using power supplied from the power supply; a controller configured to control the aerosol generator; an aerosol source accommodation part configured to allow the aerosol source to be inserted and removed, and configured to accommodate at least a part of the aerosol source; a movable member configured to move in an insertion direction accompanying insertion of the aerosol source; a biasing member configured to bias the movable member in a direction opposite to the insertion direction; and a detection device disposed inside the housing and configured to detect a movement of the movable member in the insertion direction. The controller starts generation of the aerosol when an input to the detection device is detected.

### CROSS-REFERENCE RELATED APPLICATIONS

This is a continuation of International Application No. PCT/JP2021/030441 filed on Aug. 19, 2021, the entire content of which is incorporated herein by reference.

### TECHNICAL FIELD

The present disclosure relates to a power supply unit of an aerosol generating device, an aerosol generating device, and a control method of an aerosol generating device.

### BACKGROUND

Generally, in a power supply unit of a non-combustion inhaler, a predetermined button operation or the like is requested when inhaling an aerosol.

For example, Japanese Patent Application Laid-Open Publication No. 2020-18285 (hereinafter, referred to as Patent Literature 1) describes that, in addition to an activation switch provided outside a case, a safety switch capable of sensing whether a cigarette is inserted into a device is provided, and heating is started when the safety switch and the activation switch are simultaneously closed.

However, in the electronic device for tobacco described in Patent Literature 1, in addition to the presence of the two switches, a switch operation performed by a user is required when heating is started.

Meanwhile, a non-combustion inhaler described in Japanese Patent Application Laid-Open Publication No. 2018-523982 (hereinafter, referred to as Patent Literature 2) or Japanese Patent Application Laid-Open Publication No. 2009-509521 (hereinafter, referred to as 3) is provided with a switch that operates when a smoking article is received by a housing, and automatically starts heating (hereinafter, also referred to as automatic start).

However, Patent Literature 2 or 3 does not specifically describe how to turn on the switch when the smoking article is received by the housing.

In order to realize the automatic start, it is necessary to appropriately detect insertion of the smoking article or the like.

The present disclosure provides a power supply unit of an aerosol generating device having an automatic start function of starting generation of an aerosol in response to insertion of an aerosol source, an aerosol generating device, and a control method of an aerosol generating device.

### SUMMARY

A power supply unit of an aerosol generating device according to the present disclosure includes:
a housing;
a power supply;
an aerosol generator configured to generate an aerosol from an aerosol source by using power supplied from the power supply;
a controller configured to control the aerosol generator;
an aerosol source accommodation part configured to allow the aerosol source to be inserted and removed, and configured to accommodate at least a part of the aerosol source;
a movable member configured to move in an insertion direction accompanying insertion of the aerosol source;
a biasing member configured to bias the movable member in a direction opposite to the insertion direction; and
a detection device disposed inside the housing and configured to detect a movement of the movable member in the insertion direction, in which
the controller starts generation of the aerosol when an input to the detection device is detected.

An aerosol generating device according to the present disclosure includes:
the power supply unit of an aerosol generating device; and
the aerosol source.

A control method of an aerosol generating device according to the present disclosure includes:
starting generation of an aerosol from an aerosol source based on an input to a detection device accompanying a first operation which is insertion of the aerosol source;
stopping the generation of the aerosol when a predetermined time elapses or when a predetermined number of times of inhaling is detected after the start of the generation of the aerosol; and
continuing the generation of the aerosol when the input to the detection device is detected again by a second operation different from the first operation during the generation of the aerosol.

### BRIEF DESCRIPTION OF DRAWINGS

Exemplary embodiments of the present disclosure will be described in detail based on the following figures, wherein:

FIG. 1 is a perspective view of a non-combustion inhaler;

FIG. 2 is a perspective view of the non-combustion inhaler with a rod attached;

FIG. 3 is a block diagram illustrating a control configuration of the non-combustion inhaler;

FIG. 4 is an enlarged cross-sectional view illustrating a heating unit according to a first embodiment;

FIG. 5 is an enlarged cross-sectional view illustrating a heating unit according to a second embodiment;

FIG. 6 is an enlarged cross-sectional view illustrating a heating unit according to a third embodiment;

FIG. 7 is an enlarged cross-sectional view illustrating a heating unit according to a fourth embodiment;

FIG. 8 is an enlarged cross-sectional view illustrating a heating unit according to a fifth embodiment;

FIG. 9 is an enlarged cross-sectional view illustrating an air flow path of the heating unit; and

FIG. 10 is an enlarged cross-sectional view illustrating another example of the air flow path of the heating unit.

### DESCRIPTION OF EMBODIMENTS

### (Aerosol Generating Device)

Hereinafter, an aerosol generating device and a control method thereof according to the present disclosure will be described with reference to the drawings. The aerosol generating device includes a non-combustion inhaler 100 (hereinafter, also simply referred to as “inhaler 100”) which is an embodiment of a power supply unit according to the present disclosure, and a rod 500 heated by the inhaler 100.

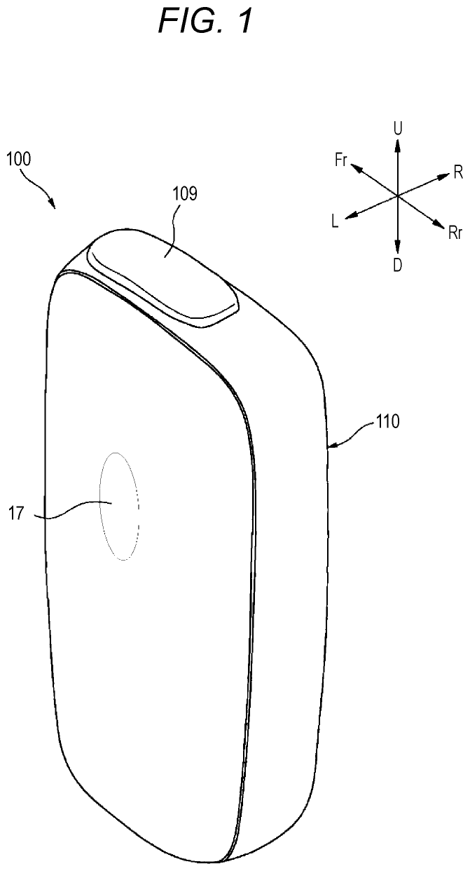

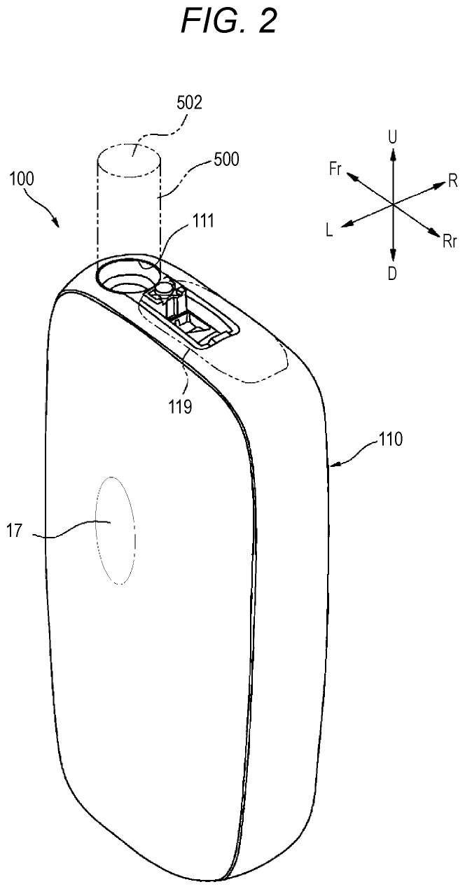

FIG. 1 is a perspective view illustrating an overall configuration of the inhaler 100. FIG. 2 is a perspective view of the inhaler 100 with the rod 500 attached. In addition, in the following description, for convenience, an orthogonal coordinate system in a three-dimensional space in which three directions orthogonal to one another are defined as a front-rear direction, a left-right direction, and an up-down direction will be described. In the drawings, a front side is denoted by Fr, a rear side is denoted by Rr, a right side is denoted by R, a left side is denoted by L, an upper side is denoted by U, and a lower side is denoted by D.

As illustrated in FIGS. 1 and 2, the inhaler 100 generates an aerosol containing a flavor by heating the rod 500 which is elongated and substantially columnar serving as an example of a flavor component generating base material including a filler or the like containing an aerosol source and a flavor source.

The rod 500 includes a filler containing an aerosol source which generates an aerosol by being heated at a predetermined temperature. The type of the aerosol source is not particularly limited, and an extract substance from various natural products and/or a constituent component thereof can be selected according to a purpose. The aerosol source may be a solid, or may be, for example, a polyhydric alcohol such as glycerin or propylene glycol, or a liquid such as water. The aerosol source may include a flavor source such as a tobacco raw material which releases a flavor component by being heated, or an extract originated from a tobacco raw material. A gas to which the flavor component is added is not limited to the aerosol, and for example, invisible steam may be generated.

The filler of the rod 500 may contain cut tobacco as the flavor source. A material for the cut tobacco is not specifically limited, and a publicly known material such as a lamina and a stem may be used as the material. The filler may contain one kind or two or more kinds of fragrances. The kinds of fragrances are not specifically limited, but in view of provision of satisfactory smoke taste, menthol is preferable. The flavor source may contain plants other than tobacco (for example, mints, herbal medicines, or herbs). The rod 500 may not contain a flavor source depending on the purpose.

The inhaler 100 may generate an aerosol by heating, instead of the rod 500, a liquid aerosol source accommodated in a cartridge. In this case, the flavor source may be included in the cartridge including the aerosol source, or the cartridge including the flavor source may be a separate body.

### (Non-Combustion Inhaler)

As illustrated in FIGS. 1 to 3, the inhaler 100 includes a case 110, a power supply 10 disposed in an internal space of the case 110, a control unit 120, and a heating unit 130. The case 110 has a substantially rectangular parallelepiped shape including a front surface, a rear surface, a left surface, a right surface, an upper surface, and a lower surface. The power supply 10 is a chargeable secondary battery, an electric double-layer capacitor, or the like, and is preferably a lithium ion secondary battery. An electrolyte of the power supply 10 may include one or a combination of a gel electrolyte, an electrolyte solution, a solid electrolyte, and an ionic liquid.

As illustrated in FIG. 2, the upper surface of the case 110 is provided with an opening 111 into which the rod 500 can be inserted, and a slider 119 that opens and closes the opening 111. The slider 119 is coupled to the case 110 in a manner of being movable in the front-rear direction between a position where the opening 111 is closed (see FIG. 1) and a position where the opening 111 is opened (see FIG. 2).

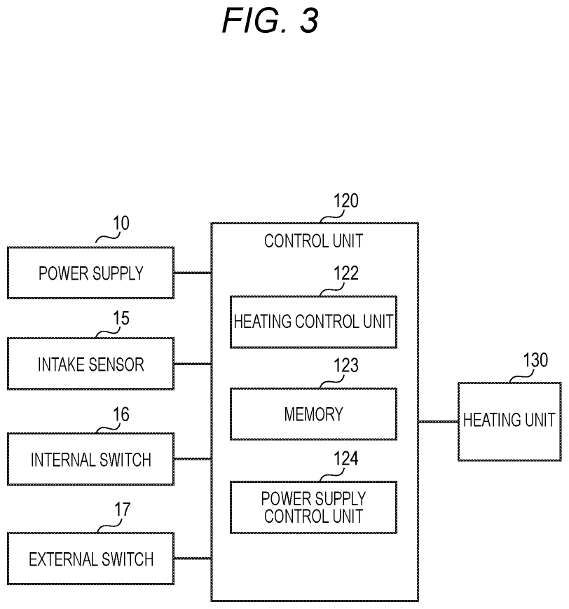

As illustrated in FIG. 3, the power supply 10, an intake sensor 15 that detects a puff (intake) operation, an internal switch 16 that detects insertion of the rod 500, and an external switch 17 that is disposed outside the case 110 and is to be operated by a user are connected to an input side of the control unit 120, and the heating unit 130 is connected to an output side of the control unit 120.

The inside of the control unit 120 includes, as functional configurations implemented by cooperation of hardware and software, a heating control unit 122 that controls the heating unit 130 based on switch signals of the internal switch 16 and the external switch 17, a memory 123 that stores a heating duration time of the heating unit 130, the number of times of the puff operation, and the like, and a power supply control unit 124 that manages charging and discharging of the power supply 10.

Specifically, the control unit 120 is a processor (computer). More specifically, a structure of the processor is an electric circuit in which circuit elements such as a half conductor element are combined. The intake sensor 15 may be implemented by a condenser microphone, a pressure sensor, or the like. Further, instead of detecting the puff by the intake sensor 15, the puff may be detected by sensing a temperature change due to the puff by using a thermistor.

The heating unit 130 heats the rod 500 inserted from the opening 111 without burning. When the rod 500 is heated, an aerosol is generated from the aerosol source contained in the rod 500, and the flavor of the flavor source contained in the rod 500 is added to the aerosol. The user can inhale the aerosol containing the flavor by holding in the mouth an inhaling port 502 of the rod 500 protruding from the opening 111 to perform inhaling. The heating unit 130 is an example of an aerosol generating unit, and a method for generating the aerosol may be a method of atomizing the aerosol source by heating such as resistance heating, induction heating, or the like, or may be a method of atomizing the aerosol source by vibration caused by ultrasonic waves, or may be other methods.

### Heating Unit According to First Embodiment

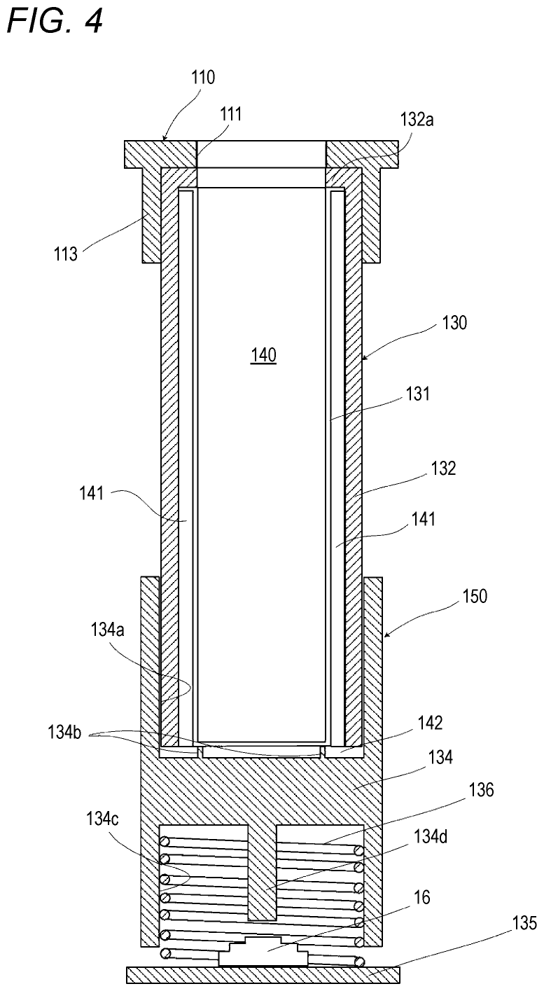

As illustrated in FIG. 4, the heating unit 130 includes a cylindrical heater 131 that heats the rod 500 from an outer circumferential side, a cylindrical heat insulating member 132 that covers an outer circumferential portion and an upper surface of the heater 131, and a bottom cap 134 that covers an outer circumferential portion on a lower side and a lower surface of each of the heater 131 and the heat insulating member 132. The heater 131 and the heat insulating member 132 have a cylindrical shape as a whole, and an inner circumferential portion of the heater 131 forms a rod accommodation portion 140 capable of accommodating a part of the rod 500. A gap 141 is provided between the outer circumferential portion of the heater 131 and the inner circumferential portion of the heat insulating member 132, and the gap 141 serves as a heat insulating space. The heater 131 may be any element that can heat the rod 500. The heater 131 is, for example, a heating element. Examples of the heating element include a heating resistor, a ceramic heater, and an induction heating heater. The heater 131 may have a structure in which a heating element is attached to a tubular support element made of a material such as SUS.

An upper end portion 132a of the heat insulating member 132 is opened, communicates with the rod accommodation portion 140 of the heater 131 accommodated inside the heat insulating member 132, and communicates with the opening 111 of the case 110. The upper end portion 132a of the heat insulating member 132 slidably fits into a cylindrical fitting recessed portion 113 extending inward of the case from the periphery of the opening 111.

On an upper portion of the bottom cap 134, a fitting recessed portion 134a is recessed downward. The fitting recessed portion 134a fits into a lower end portion of the heat insulating member 132. Ribs 134b for ensuring a gap between a bottom surface of the fitting recessed portion 134a and a lower end surface of the heater 131 is provided on the bottom surface of the fitting recessed portion 134a in a protruding manner. A gap 142 between the bottom surface of the fitting recessed portion 134a and the lower end surface of the heater 131 also serves as a heat insulating space.

The bottom cap 134 according to the present embodiment is movable in the up-down direction integrally with the heater 131 and the heat insulating member 132. A lower portion of the bottom cap 134 is formed with an elastic member accommodation portion 134c recessed upward, and a switch pressing portion 134d extending downward from a center of a top surface portion of the elastic member accommodation portion 134c.

A substrate 135 on which the internal switch 16 is mounted is disposed below the bottom cap 134. A biasing member 136 (for example, a compression coil spring) that biases the bottom cap 134 upward is interposed between the top surface portion of the clastic member accommodation portion 134c of the bottom cap 134 and the upper surface portion of the substrate 135.

The internal switch 16 according to the present embodiment is a contact type switch that is turned ON/OFF in response to a pressing operation. The internal switch 16 is disposed below the switch pressing portion 134d of the bottom cap 134, and when the bottom cap 134 is positioned at an upper position due to a biasing force of the biasing member 136, the internal switch 16 is in a non-pressed state and maintains the OFF state. Meanwhile, when the bottom cap 134 moves downward against the biasing force of the biasing member 136, the switch pressing portion 134d of the bottom cap 134 presses the internal switch 16, and the internal switch 16 is switched to the ON state. The bottom cap 134 according to the present embodiment slides integrally with the heater 131 and the heat insulating member 132, and thus in the following description, the heater 131, the heat insulating member 132, and the bottom cap 134 are referred to as a heater unit 150.

Next, operations of the heating unit 130 and the control unit 120 accompanying the insertion of the rod 500 will be described. FIG. 4 is an enlarged cross-sectional view illustrating the heating unit 130 in a state in which the rod 500 is not inserted, and in this state, the heater unit 150 is positioned at the upper position (hereinafter, may be referred to as an initial position.) due to the biasing force of the biasing member 136, and the internal switch 16 is in the non-pressed state and maintains the OFF state.

When the user inserts the rod 500 into the rod accommodation portion 140, a lower end portion of the rod 500 presses the bottom cap 134 downward. When the bottom cap 134 is pressed downward, the heater unit 150 moves downward (hereinafter, may be referred to as a switch action position) against the biasing force of the biasing member 136. When the heater unit 150 moves downward, the switch pressing portion 134d of the bottom cap 134 presses the internal switch 16, and the internal switch 16 is switched to the ON state.

When receiving an ON signal of the internal switch 16, the control unit 120 causes the heater 131 to operate to start heating the rod 500. In this way, the control unit 120 automatically starts heating by the heating unit 130 in response to the insertion of the rod 500, whereby automatic start of the inhaler 100 can be appropriately realized.

When an insertion operation of the rod 500 performed by the user is completed, the heater unit 150 immediately returns to the initial position due to the biasing force of the biasing member 136. That is, the heater unit 150 is positioned at the initial position during the heating of the rod 500. According to the heating unit 130 having such a configuration, the heater unit 150 moves from the initial position to the switch action position only when the rod 500 is inserted, and thus it is sufficient to set an air flow during heating at the initial position, and the structure can be simplified. The air flow during heating will be described later.

In the present embodiment, the heater unit 150 including the bottom cap 134 moves vertically, whereby a relative positional relation between the bottom cap 134 and the heat insulating member 132 is maintained. Therefore, it is possible to prevent a secondhand smoke leak from occurring between the bottom cap 134 and the heat insulating member 132.

After automatically starting the heating operation of the heater 131 in response to the insertion of the rod 500, the control unit 120 continues the heating operation of the heater 131 for a predetermined time or until a predetermined number of times of inhaling is detected. When the predetermined time elapses or the predetermined number of times of inhaling is detected after the start of heating, the heating operation of the heater 131 is stopped. In this way, by estimating depletion of the aerosol source according to the duration time of heating or the number of times of inhaling, and automatically stopping the heating, not only the start of heating but also the stop of heating can be automatically performed.

When detecting the ON signal of the internal switch 16 again during the heating operation of the heater 131, the control unit 120 continues the heating operation of the heater 131. The case in which the control unit 120 detects the ON signal of the internal switch 16 again during the heating operation of the heater 131 refers to a case in which the rod 500 is pressed in the same direction as the insertion direction and the heater unit 150 presses the internal switch 16 at the switch action position in a state in which the rod 500 is already accommodated in the rod accommodation portion 140. That is, the operation is different from the insertion of the rod 500 in that the rod 500 is already accommodated in the rod accommodation portion 140. According to such control, also in the case in which the user unintentionally presses the rod 500 in the insertion direction during the heating operation of the heater 131 and the heater unit 150 moves in the insertion direction, the heating operation of the heater 131 is continued, and thus the heating can be prevented from stopping although the user does not intend.

When the external switch 17 is operated during the heating operation of the heater 131, the control unit 120 stops the heating operation of the heater 131. According to such control, the heating can be stopped in an emergency or in accordance with an intention of the user, whereby usability can be improved.

### Heating Unit According to Second Embodiment

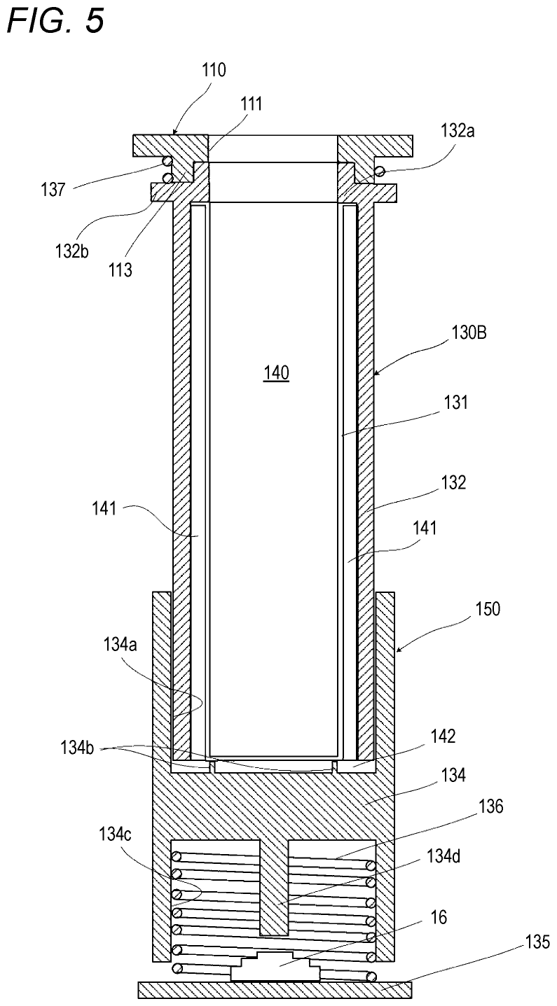

Next, heating units 130B to 130E according to second to fifth embodiments will be described with reference to FIGS. 5 to 8. However, regarding configurations common to those according to the embodiment described above, the same reference numerals as those in the embodiment described above are used, and the description of the embodiment described above may be referred to.

In the heating unit 130B according to the second embodiment illustrated in FIG. 5, a biasing member 137 that biases the heat insulating member 132 downward is added between the case 110 and the upper end portion 132a of the heat insulating member 132. Specifically, the biasing member 137 is disposed between the case 110 and a flange portion 132b formed on the upper end portion 132a of the heat insulating member 132.

According to the heating unit 130B of the second embodiment, when a user inserts the rod 500 into the rod accommodation portion 140, a biasing force of the biasing member 137 is added to a force by which a lower end portion of the rod 500 presses the bottom cap 134 downward, and thus the heater unit 150 is likely to move to a switch action position. Accordingly, the switch pressing portion 134d of the bottom cap 134 can reliably press the internal switch 16. The biasing force of the biasing member 137 is set to be smaller than the biasing force of the biasing member 136, and the heating unit 130B is the same as that of the first embodiment in that the heater unit 150 including the bottom cap 134 moves from the initial position to the switch action position only when the rod 500 is inserted.

### Heating Unit According to Third Embodiment

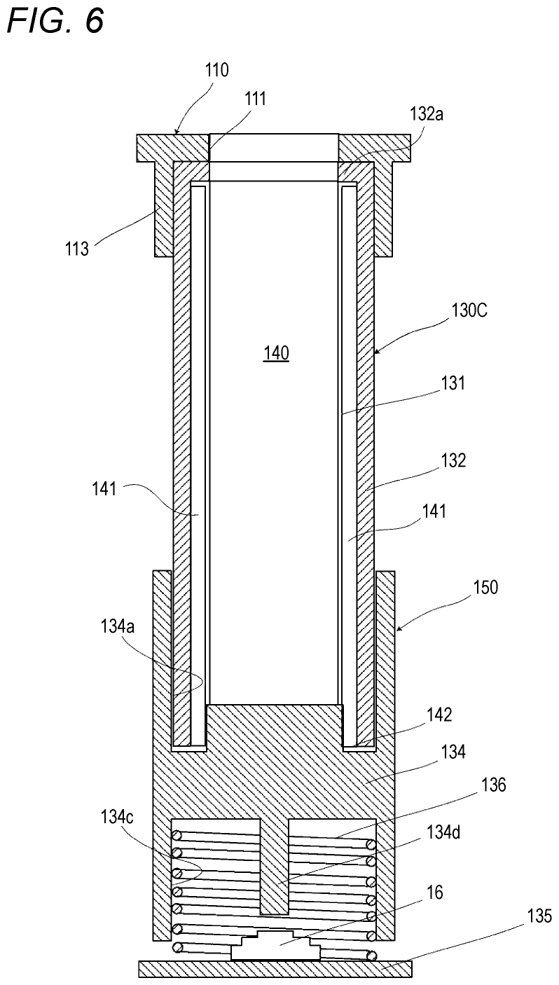

The heating unit 130C according to the third embodiment illustrated in FIG. 6 is different from those of the first embodiment and the second embodiment in that the heater 131 and the heat insulating member 132 are fixed to the case 110 so as not to be vertically movable, and only the bottom cap 134 moves downward when the rod 500 is inserted. In other words, the bottom cap 134 according to the third embodiment is movable relative to the heater 131 and the heat insulating member 132. According to the heating unit 130C of the third embodiment, the number of members that move when the rod 500 is inserted is set to be minimum, and a structure can be simplified. A heat-resistant lubricating material is preferably provided on a sliding surface between the bottom cap 134 and the heat insulating member 132. Accordingly, it is possible to prevent a secondhand smoke leak from occurring between the bottom cap 134 and the heat insulating member 132. Not limited to the third embodiment, the lubricant may be provided between the bottom cap 134 and the heat insulating member 132 in another embodiment.

### Heating Unit According to Fourth Embodiment

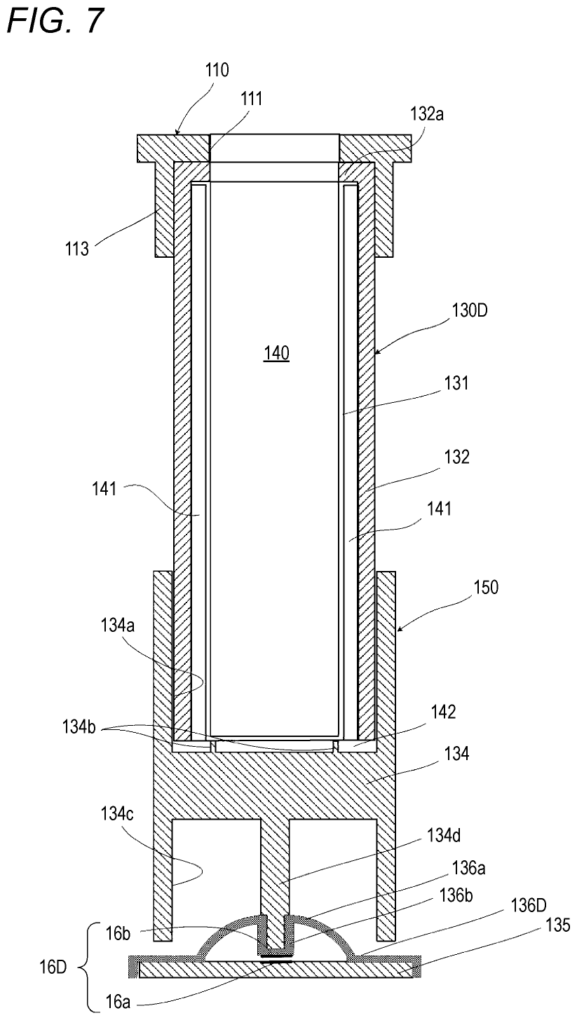

The heating unit 130D according to the fourth embodiment illustrated in FIG. 7 is different from those of the embodiments described above in configurations of a biasing member 136D and an internal switch 16D. The biasing member 136D according to the fourth embodiment is a rubber sheet (a rubber elastic member) that covers an upper surface side of the substrate 135, and a bulge portion 136a bulging upward is formed at a position facing a lower end portion of the switch pressing portion 134d. The bulge portion 136a is in contact with the lower end portion of the switch pressing portion 134d, and thus the bottom cap 134 can be biased upward.

The biasing member 136D includes a convex portion 136b extending downward from a top portion of the bulge portion 136a and having a lower end portion close to a fixed contact point 16a on the substrate 135. A movable contact point 16b (carbon, gold plating, or the like) is provided on a lower end surface of the convex portion 136b, and the internal switch 16D according to the fourth embodiment is implemented by the contact points 16a and 16b. At an initial position, the contact points 16a and 16b are separated from each other, and when the bottom cap 134 moves downward in response to insertion of the rod 500, the bulge portion 136a of the biasing member 136D is elastically deformed in a compressing direction, and accordingly, the movable contact point 16b comes into contact with the fixed contact point 16a on the substrate 135 and the internal switch 16D is switched to an ON state.

According to the fourth embodiment, the biasing member 136D covers the internal switch 16D and isolates a space in which the internal switch 16D is disposed from a surrounding space. That is, the biasing member 136D covers the internal switch 16D and disposes the internal switch 16D in a space different from the surrounding space. Therefore, even when secondhand smoke leaks to the elastic member accommodation portion 134c, the internal switch 16D can be protected, and a malfunction of the internal switch 16D can be prevented. The biasing member 136D according to the fourth embodiment can be used instead of the biasing member 136 (for example, the compression coil spring) of the first to third embodiments described with reference to FIGS. 4 to 6.

### Heating Unit According to Fifth Embodiment

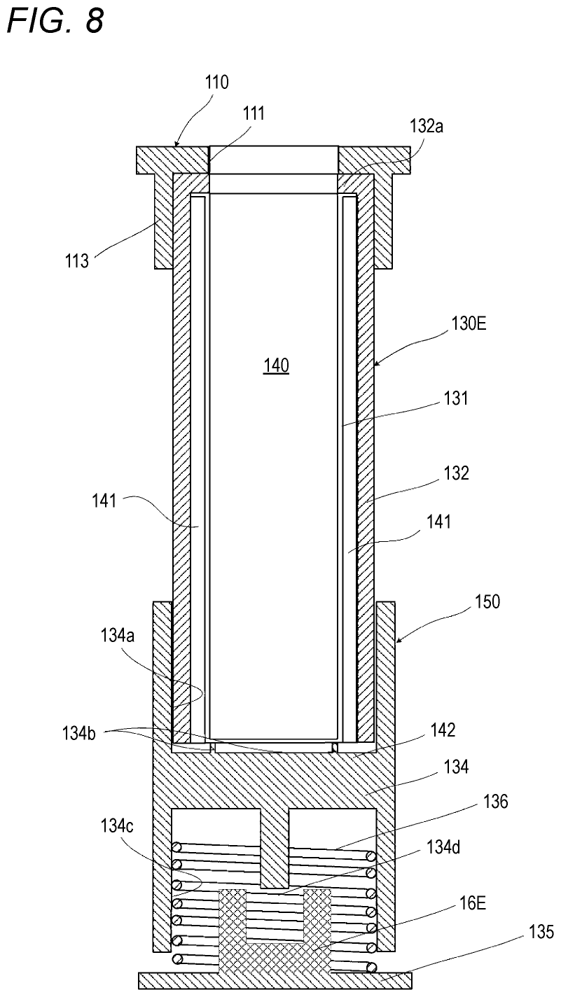

The heating unit 130E according to the fifth embodiment illustrated in FIG. 8 is different from the embodiments described above in that an internal switch 16E is a non-contact type switch. The non-contact type switch is, for example, a photo interrupter, and when the bottom cap 134 moves downward in response to insertion of the rod 500, the switch pressing portion 134d of the bottom cap 134 blocks an optical path of the photo interrupter, thereby switching to the ON state. According to the fifth embodiment, by implementing the internal switch 16E with a non-contact type switch, a failure, a malfunction, or the like caused by contact or failure of a contact point can be avoided. The internal switch 16E according to the fifth embodiment can be used instead of the internal switches 16 to the first to third embodiments described with reference to FIGS. 4 to 6 and the internal switch 16D according to the fourth embodiment described with reference to FIG. 7.

### (Air Flow Path)

In the aerosol generating device, when the aerosol source is heated in the heating units 130 and 130B to 130E, the aerosol source generated due to atomization is supplied to the inhaling port 502 of the rod 500 together with air taken into the case 110. In the descriptions of the first to fifth embodiments described above, the flow of air taken into the case 110 is described, and in the following, two examples of the flow of air to the heating units 130 and 130B to 130E will be described by using the heating unit 130 according to the first embodiment.

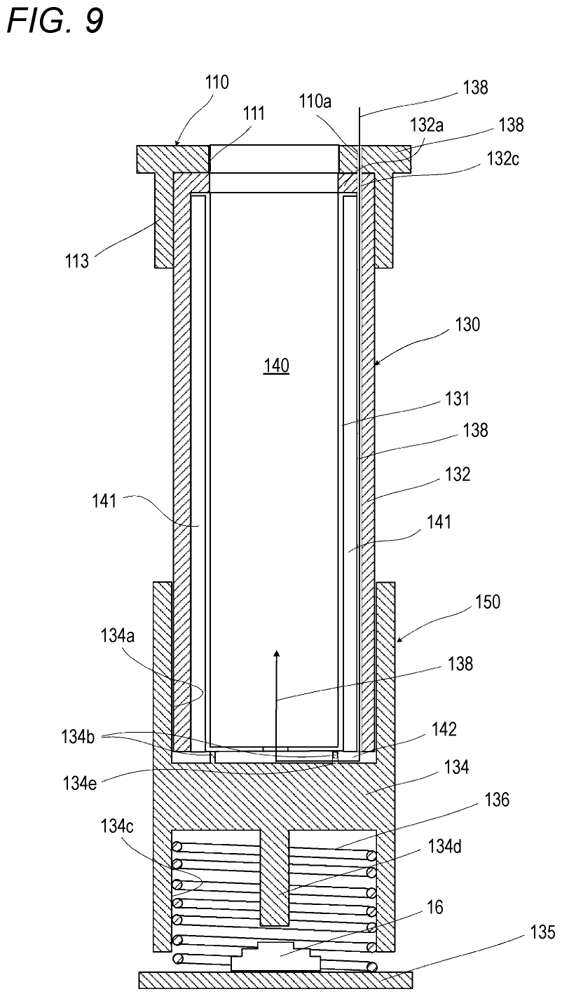

FIG. 9 is an enlarged cross-sectional view illustrating an air flow path 138 of the heating unit 130. The air flow path 138 illustrated in FIG. 9 includes vent holes 110a and 132c respectively formed in the case 110 and the heat insulating member 132, the gap 141 between an outer circumferential surface of the heater 131 and an inner circumferential surface of the heat insulating member 132, a gap 142 between the bottom surface of the fitting recessed portion 134a and the lower end surface of the heater 131, and notches 134e formed in a part of the rib 134b. Accordingly, when the user inhales air from the inhaling port 502 of the rod 500, the air introduced into the case 110 through the vent holes 110a and 132c is supplied to the inhaling port 502 through the gap 141 between the heater 131 and the heat insulating member 132 and the gap 142 between the heater 131 and the bottom cap 134 together with the aerosol generated due to atomization. According to such a configuration, the internal switch 16 can be isolated from the air flow path 138, and a malfunction of the internal switch 16 can be prevented. As an additional configuration or a configuration for replacing the air flow path 138, a gap between the rod 500 and the rod accommodation portion 140 may serve as an air flow path. In this case, a convex portion or a recessed portion may be provided on an inner surface of the rod accommodation portion 140 to ensure the gap between the rod accommodation portion 140 and rod 500.

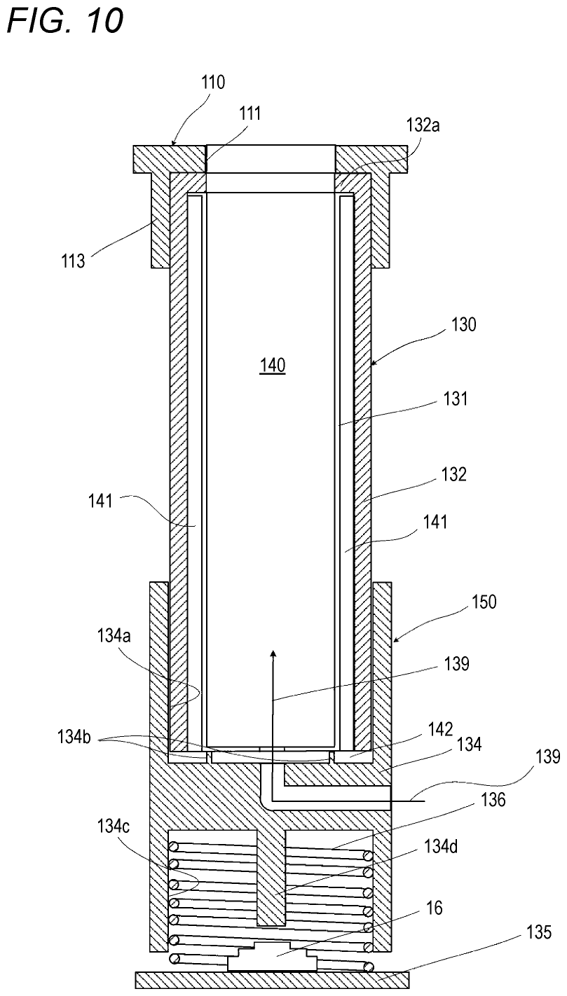

FIG. 10 is an enlarged cross-sectional view illustrating an air flow path 139 of the heating unit 130. At least a part of the air flow path 139 illustrated in FIG. 10 is formed in the bottom cap 134. A vent hole for introducing outside air to the case 110 may be positioned at any position of the case 110, and is not particularly limited. In this case, when the user inhales air from the inhaling port 502 of the rod 500, the air introduced into the case 110 through the vent hole (not illustrated) is supplied to the inhaling port 502 through the air flow path 139 of the bottom cap 134 together with the aerosol generated due to atomization. According to such a configuration, the bottom cap 134 also serves as a member forming a part of the air flow path 139, thereby reducing the number of components and reducing the cost.

In the case illustrated in FIG. 9 or 10, the internal switch 16 is disposed at a position other than the air flow path 138 or 139. The position other than the air flow path 138 or 139 is a position at which the internal switch 16 is not exposed to the air flowing through the air flow path 138 or 139. By disposing the internal switch 16 at a position other than the air flow path 138 or 139, the internal switch 16, which is a precision component, can be isolated from the air flow path 138 or 139. Accordingly, it is possible to reduce a possibility that air gives a bad influence on the internal switch 16, and to prevent a malfunction of the internal switch 16.

Although various embodiments have been described above with reference to the drawings, it is needless to say that the present invention is not limited to these examples. It is apparent to those skilled in the art that various changes and modifications may be conceived within the scope described in the claims, and it is understood that the changes and the modifications naturally fall within the technical scope of the present invention. In addition, the components described in the above embodiments may be optionally combined without departing from the spirit of the invention.

For example, in the embodiments described above, the heating unit that consumes the power supplied from the power supply 10 and heats the aerosol source is the heater 131, but the present invention is not limited thereto. For example, the heating unit that generates the aerosol may include a susceptor built in the rod 500 and an induction heating coil that transmits power to the susceptor by electromagnetic induction.

In the present description, at least the following matters are described. In parentheses, corresponding constituent components and the like in the embodiment described above are indicated, but the present invention is not limited thereto.
(1) A power supply unit (non-combustion inhaler 100) of an aerosol generating device, including:
a housing (case 110);
a power supply (power supply 10);
an aerosol generating unit (heating unit 130, heating unit 130B, heating unit 130C, heating unit 130D, heating unit 130E) configured to generate an aerosol from an aerosol source (rod 500) by using power supplied from the power supply;
a control unit (control unit 120) configured to control the aerosol generating unit;
an aerosol source accommodation unit (rod accommodation portion 140) configured to allow the aerosol source to be inserted and removed, and configured to accommodate at least a part of the aerosol source;
a movable member (heater unit 150, bottom cap 134) configured to move in an insertion direction accompanying insertion of the aerosol source;
a biasing member (biasing member 136, biasing member 136D) configured to bias the movable member in a direction opposite to the insertion direction; and
a detection device (internal switch 16, internal switch 16D, internal switch 16E) disposed inside the housing and configured to detect a movement of the movable member in the insertion direction, in which
the control unit starts generation of the aerosol when an input to the detection device is detected.

According to (1), due to the insertion of the aerosol source, the movable member moves in the insertion direction against the biasing member, the detection device detects the movement of the movable member in the insertion direction, and the control unit starts generation of the aerosol, and thus automatic start can be appropriately realized.
(2) The power supply unit of an aerosol generating device according to (1), in which
the detection device (internal switch 16) is a contact type switch, and is disposed in a manner of coming into contact with the movable member when the aerosol source is inserted and the movable member moves in the insertion direction.

According to (2), when the detection device comes into contact with the movable member, a generation start timing of the aerosol can be appropriately detected.
(3) The power supply unit of an aerosol generating device according to (1), in which
the detection device (internal switch 16D) is a contact type switch, and is disposed in a manner of coming into contact with the biasing member when the aerosol source is inserted and the movable member moves in the insertion direction.

According to (3), when the detection device comes into contact with the biasing member, the generation start timing of the aerosol can be appropriately detected.
(4) The power supply unit of an aerosol generating device according to (3), in which
the biasing member covers the detection device and is configured to dispose the detection device in a space different from a surrounding space.

According to (4), the detection device, which is a precision component, can be disposed in a space different from the surrounding space, and thus a malfunction of the detection device can be prevented.
(5) The power supply unit of an aerosol generating device according to (1), in which
the detection device (internal switch 16E) is a non-contact type switch, and is configured to detect a movement of the movable member or the biasing member when the aerosol source is inserted and the movable member moves in the insertion direction.

According to (5), the detection device is a non-contact type switch, and thus a failure of the detection device due to contact can be avoided.
(6) The power supply unit of an aerosol generating device according to any one of (1) to (5), further including:
an air flow path (air flow path 138, air flow path 139) configured to introduce outside air into the aerosol source accommodation unit, in which
the detection device is disposed at a position other than the air flow path.

According to (6), the detection device, which is a precision component, can be isolated from the air flow path, and thus a malfunction of the detection device can be prevented.
(7) The power supply unit of an aerosol generating device according to (6), in which
the movable member includes at least a part of the air flow path.

According to (7), the movable member also serves as a member forming a part of the air flow path, and thus the number of components can be reduced, and the cost of the power supply unit of the aerosol generating device can be reduced.
(8) The power supply unit of an aerosol generating device according to any one of (1) to (7), in which
the movable member is configured to move between an initial position and an action position at which the movable member acts on the detection device when the aerosol source is inserted, and
the movable member is positioned at the initial position during the generation of the aerosol.

According to (8), the movable member moves from the initial position to the action position only when the aerosol source is inserted, and thus the air flow during generating the aerosol can be set at the initial position, and the structure can be simplified.
(9) The power supply unit of an aerosol generating device according to any one of (1) to (8), in which
the control unit is configured to
   continue the generation of the aerosol until a predetermined time or a predetermined number of times of inhaling is detected after the start of the generation of the aerosol, and
   stop the generation of the aerosol when the predetermined time elapses or when the predetermined number of times of inhaling is detected.

According to (9), when the predetermined time elapses or when the predetermined number of times of inhaling is detected, the control unit stops the generation of the aerosol, thereby estimating the depletion of the aerosol source and automatically stopping the generation of the aerosol. Accordingly, not only the start of the generation of the aerosol but also the stop of the generation of the aerosol can be automatically performed.
(10) The power supply unit of an aerosol generating device according to (9), in which
the control unit is configured to continue the generation of the aerosol when the input to the detection device is detected again during the generation of the aerosol.

According to (10), also in a case in which a load is unintentionally applied in the insertion direction of the aerosol source during the generation of the aerosol and the movable member moves in the insertion direction, the generation of the aerosol can be prevented from being unintentionally stopped by continuing the generation of the aerosol.
(11) The power supply unit of an aerosol generating device according to any one of (1) to (10), further including:
an operation switch (external switch 17) that is exposed to an outside of the housing and is configured to prohibit the generation of the aerosol.

According to (11), the generation of the aerosol can be stopped in an emergency or in accordance with an intention of the user, whereby usability can be improved.
(12) An aerosol generating device, including:
the power supply unit of an aerosol generating device according to any one of (1) to (11) (non-combustion inhaler 100); and
the aerosol source.

According to (12), due to the insertion of the aerosol source, the movable member moves in the insertion direction against the biasing member, the detection device detects the movement of the movable member in the insertion direction, and the control unit starts generation of the aerosol, and thus automatic start can be appropriately realized.
(13) A control method of an aerosol generating device, including:
starting generation of an aerosol from an aerosol source based on an input to a detection device (internal switch 16, internal switch 16D, internal switch 16E) accompanying a first operation which is insertion of the aerosol source;
stopping the generation of the aerosol when a predetermined time elapses or when a predetermined number of times of inhaling is detected after the start of the generation of the aerosol; and
continuing the generation of the aerosol when the input to the detection device is detected again by a second operation different from the first operation during the generation of the aerosol.

According to (13), automatic start due to the insertion of the aerosol source and automatic stop can be realized, and deterioration of usability due to an erroneous operation of the user can be prevented.
(14) The control method of an aerosol generating device according to (13), further including:
prohibiting the generation of the aerosol based on an input to another detection device (external switch 17) different from the detection device.

According to (14), the generation of the aerosol can be stopped in an emergency or in accordance with an intention of the user, whereby usability can be further improved.

1. A power supply unit of an aerosol generating device, comprising:
a housing;
a power supply;
an aerosol generator configured to generate an aerosol from an aerosol source by using power supplied from the power supply;
a controller configured to control the aerosol generator;
an aerosol source accommodation part configured to allow the aerosol source to be inserted and removed, and configured to accommodate at least a part of the aerosol source;
a movable member configured to move in an insertion direction accompanying insertion of the aerosol source;
a biasing member configured to bias the movable member in a direction opposite to the insertion direction; and
a detection device disposed inside the housing and configured to detect a movement of the movable member in the insertion direction, wherein
the controller starts generation of the aerosol when an input to the detection device is detected.

2. The power supply unit of an aerosol generating device according to claim 1, wherein
the detection device is a contact type switch, and is disposed in a manner of coming into contact with the movable member when the aerosol source is inserted and the movable member moves in the insertion direction.

3. The power supply unit of an aerosol generating device according to claim 1, wherein
the detection device is a contact type switch, and is disposed in a manner of coming into contact with the biasing member when the aerosol source is inserted and the movable member moves in the insertion direction.

4. The power supply unit of an aerosol generating device according to claim 3, wherein
the biasing member covers the detection device and is configured to dispose the detection device in a space different from a surrounding space.

5. The power supply unit of an aerosol generating device according to claim 1, wherein
the detection device is a non-contact type switch, and is configured to detect a movement of the movable member or the biasing member when the aerosol source is inserted and the movable member moves in the insertion direction.

6. The power supply unit of an aerosol generating device according to claim 1, further comprising:
an air flow path configured to introduce outside air into the aerosol source accommodation part, wherein
the detection device is disposed at a position other than the air flow path.

7. The power supply unit of an aerosol generating device according to claim 6, wherein
the movable member includes at least a part of the air flow path.

8. The power supply unit of an aerosol generating device according to claim 1, wherein
the movable member is configured to move between an initial position and an action position at which the movable member acts on the detection device when the aerosol source is inserted, and
the movable member is positioned at the initial position during the generation of the aerosol.

9. The power supply unit of an aerosol generating device according to claim 1, wherein
the controller is configured to
continue the generation of the aerosol until a predetermined time or a predetermined number of times of inhaling is detected after the start of the generation of the aerosol, and
stop the generation of the aerosol when the predetermined time elapses or when the predetermined number of times of inhaling is detected.

10. The power supply unit of an aerosol generating device according to claim 9, wherein
the controller is configured to continue the generation of the aerosol when the input to the detection device is detected again during the generation of the aerosol.

11. The power supply unit of an aerosol generating device according to claim 1, further comprising:
an operation switch that is exposed to an outside of the housing and is configured to prohibit the generation of the aerosol.

12. An aerosol generating device, comprising:
the power supply unit of an aerosol generating device according to claim 1; and
the aerosol source.

13. A control method of an aerosol generating device, comprising:
starting generation of an aerosol from an aerosol source based on an input to a detection device accompanying a first operation which is insertion of the aerosol source;
stopping the generation of the aerosol when a predetermined time elapses or when a predetermined number of times of inhaling is detected after the start of the generation of the aerosol; and
continuing the generation of the aerosol when the input to the detection device is detected again by a second operation different from the first operation during the generation of the aerosol.

14. The control method of an aerosol generating device according to claim 13, further comprising:
prohibiting the generation of the aerosol based on an input to another detection device different from the detection device.

15. An aerosol generating device, comprising:
the power supply unit of an aerosol generating device according to claim 2; and
the aerosol source.

16. An aerosol generating device, comprising:
the power supply unit of an aerosol generating device according to claim 3; and
the aerosol source.

17. An aerosol generating device, comprising:
the power supply unit of an aerosol generating device according to claim 4; and
the aerosol source.

18. An aerosol generating device, comprising:
the power supply unit of an aerosol generating device according to claim 5; and
the aerosol source.

19. An aerosol generating device, comprising:
the power supply unit of an aerosol generating device according to claim 6; and
the aerosol source.

20. An aerosol generating device, comprising:
the power supply unit of an aerosol generating device according to claim 7; and
the aerosol source.
